(19) United States
(12) Patent Application Publication
(10) Pub. No.: US 2014/0222582 A1
(43) Pub. Date: Aug. 7, 2014

(54) ADVERTISEMENT BIDDING SYSTEM AND METHOD

(71) Applicants: Blake Anthony Papalia, West Palm Beach, FL (US); Shmuel Hen, Aventura, FL (US); Ilan Hondiashvili, Aventura, FL (US); Liron Knot, Sunny Isles Beach, FL (US)

(72) Inventors: Blake Anthony Papalia, West Palm Beach, FL (US); Shmuel Hen, Aventura, FL (US); Ilan Hondiashvili, Aventura, FL (US); Liron Knot, Sunny Isles Beach, FL (US)

(21) Appl. No.: 13/759,120

(22) Filed: Feb. 5, 2013

(51) Int. Cl. G06Q 30/02

(52) U.S. Cl. CPC G06Q 30/0269
USPC 705/14.66

(57) ABSTRACT

A system and method for electronic advertisement bidding based on a plurality of electronic display devices mounted in at least two different categories of locations. The invention includes a server operable to receive from an advertiser a selection of one of the at least two different categories of locations. The invention further selectively display of advertising content only on the selected one of the at least two different categories of locations. An alternate location for advertisement space may be provided for displaying an advertisement that is associated with a losing bid.

### FIELD OF THE INVENTION

The present invention relates generally to the field of advertisements, and more particularly relates to a system and method for advertisement bidding and location selection.

### BACKGROUND OF THE INVENTION

Advertising is the epitome of ubiquity, and it is hopelessly futile to deny the fact that advertising makes the world go around. Advertising is on the back of the cars we drive and the front of the clothes we wear; it is what makes radio and television possible, and it is what allows some businesses to flourish and others to fail. Advertising comes in all forms, and many highly intelligent individuals have spent entire careers trying to perfect it. The perfect advertisement is one that places the proper content in front of the person most likely to be interested in that content. This, of course, involves a strategic matching between the content and the time, place, manner, audience, and many other factors pertaining to the presentation of that content.

When a desirable advertising medium is recognized, multiple advertisers will be interested in taking advantage of the opportunity. Naturally, interest has its limits and dwindles as cost rises beyond a certain threshold. It is a constant burden on the advertisement facilitator to determine the proper price to place on the advertisement so that it can retain the interest of the advertiser and yet maximize profits. One method is to set a fixed price and hope that price is acceptable to at least one advertiser. The other is to allow the advertisers to bid on the opportunity.

Online bidding systems typically relate to either an online marketplace where users meet to buy and sell commodities, auction items, or search engine based targeted advertising. As it relates to advertising, search engine based Internet advertisement bidding systems are flourishing with the advent of Google AdWords and other advertisement bidding systems. Typical online advertisement bidding systems relate to a pay-per-click model that charges the advertiser a cost for each time that a sponsor link is clicked by a user. The advertiser is receiving advertisement space on the search engine or other World Wide Web space based on targeted search campaigns. Search engine based internet advertisement bidding systems are based on keyword search and geographic location but cannot target a specific identifiable location. For example, advertisements target users based in part upon the terms that they enter into the search engine either in real time or during past searches. Additionally, advertisements target users based in part upon identification information provided by the user to the search engine. For example, a user may provide GOOGLE with their name, age, sex, and other identifying information which can be used in combination with the search terms the user enters into the search engine.

Although internet advertisement bidding systems exist generally, several shortcomings also exist. For example, known internet advertisement bidding systems are limited to advertising to people who perform internet based searches based on keywords derived from words and phrases. Additionally, the internet advertisement bidding systems are limited to web searches. Furthermore, known internet advertisement bidding systems do not provide a system and method for providing selective bidding on a particular digital advertising space that can be targeted to a particular location and/or gender for causing the display of a particular advertisement broadcast. Additionally, internet advertisement bidding systems do not provide for bidding on video advertising space on the World Wide Web, on billboards, restroom hand dryers and other known and unknown advertising space. In other words, there is no current advertising system that allows an advertiser to specifically select a public location where the advertiser would like digital content displayed. In particular, advertisers cannot currently select, for example, a particular restaurant, store, elevator, bathroom, lavatory, etc., where it wants its content displayed. Further, there is no system that allows that advertiser to determine what it wants to pay for taking advantage of such targeted advertising.

Therefore, a need exists to overcome the problems with the prior art as discussed above. In particular, there is a need to offer an internet advertisement bidding system for video advertisement space. This includes the need to provide gender targeted video advertisements.

### SUMMARY OF THE INVENTION

The invention provides an advertisement bidding system and method that overcomes the hereinafore-mentioned disadvantages of the heretofore-known devices and methods of this general type and that allows an advertiser to participate remotely in a bidding system for selecting the location for digital display of its advertising content and the price that it is willing to pay via an online or other bidding process.

The present invention provides a system and method for electronic advertisement bidding based on a plurality of electronic display devices mounted in at least two different categories of locations. In a particular embodiment, the electronic advertising system is comprised of a plurality of electronic display devices mounted in at least two different non-geographic categories of locations. The electronic advertising system further includes a server operable to receive from an advertiser a selection of one of the at least two different non-geographic categories of locations. Yet further, the electronic advertising system includes a processor communicatively coupled to the server and the plurality of electronic display devices and operable to selectively display advertising content only on the selected one of the at least two different non-geographic categories of locations.

In accordance with another feature of the present invention, a first one of the at least two different non-geographic categories of locations is a men's lavatory and a second one of the at least two different non-geographic categories of locations is a women's lavatory.

In accordance with a further feature of the present invention, the server is further operable to receive, from at least two advertisers, at least two bids for displaying the advertising content in one of the at least two different non-geographic categories of locations. Additionally, the processor is further operable to identify a winning bid based on at least the value of the at least two bids.

In accordance with yet a further feature of the present invention, the server is further operable to receive, from the at least two advertisers, at least two bids submitted in sequential order for a video advertisement in one of the at least two different electronic display devices located in a single non-geographic category of locations. The processor is further operable to identify a winning bid based on at least the value of the at least two bids for a video advertisement in one of the at least two different electronic display devices located in a single non-geographic category of locations.

In accordance with an additional feature of the present invention, the processor causes a display of the video advertisement on a selected one of the electronic display devices located in the winning non-geographic category.

In accordance with yet an additional feature of the present invention, a switch is configured to interrupt the advertising content on at least one of the electronic display device.

In accordance with still another feature of the present invention, a camera feed is displayed on at least one of the electronic display devices after the interruption of advertising content.

In accordance with another feature of the present invention, the plurality of electronic display devices are mounted on a mobile vehicle for providing a digital mobile billboard.

In accordance with another feature of the present invention, the plurality of electronic display devices include at least one of a display on an hand dryer; a display above a urinal; a display within a restroom stall; and a display above a sink.

In accordance with another feature, an embodiment of the present invention provides a method for advertising. The method comprises receiving, from at least two advertisers, over an electronic network, at least two bids for video advertisement space on at least one electronic display device located within a selected one of a men's lavatory and a women's lavatory. The method further comprises identifying a winning bid. Additionally, the method comprises selectively displaying, for the advertiser submitting the winning bid, advertising content on the selected electronic display device.

In accordance with an additional feature of the present invention, the video advertisement space is within a selected one of at least two different categories of business establishments.

In accordance with yet an additional feature of the present invention, at least two different categories of business establishments are non-geographic categories.

In accordance with an additional feature of the present invention, the method includes interrupting, via a switch, the advertising content, wherein the interruption of the advertising content causes at least one camera image to display on the selected electronic display device.

In accordance with an additional feature of the present invention, the method includes selectively displaying, for the advertiser not submitting the winning bid, advertising content on a selected second-choice electronic display device

In accordance with an additional feature of the present invention, the method includes mounting a plurality of electronic display devices in at least two different non-geographic categories of locations. The method further includes receiving from an advertiser, through a server, a selection of one of the at least two different non-geographic categories of locations. Additionally, the method includes selectively displaying advertising content only on the selected one of the at least two different non-geographic categories of locations.

In accordance with an additional feature of the present invention, the method wherein a first one of the at least two different non-geographic categories of locations is a men's lavatory and a second one of the at least two different non-geographic categories of locations is a women's lavatory.

In accordance with an additional feature of the present invention, the method includes receiving, from the at least two advertisers, at least two bids for displaying the advertising content in one of the at least two different non-geographic categories of locations. The method additionally includes identifying a winning bid.

In accordance with an additional feature of the present invention, the method includes receiving, from at the least two advertisers, at least two bids for a video advertisement in one of the at least two different electronic display devices located in a single non-geographic category of locations. The method additionally includes identifying a winning bid based on at least the value of the at least two bids for a video advertisement in one of the at least two different electronic display devices located in a single non-geographic category of locations.

In accordance with another feature of the present invention, the method includes selectively displaying, for the advertiser not submitting the winning bid, advertising content on a selected second-choice electronic display device.

In accordance with another feature of the present invention, the method includes selectively displaying, for the advertiser not submitting the winning bid, advertising content on a selected second-choice electronic display device. Although the invention is illustrated and described herein as embodied in an advertisement bidding system and method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting, but rather to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of an advertisement bidding system that demonstrates an exemplary system for causing the display of video advertisements on a hand dryer in accordance with the principles of the present invention;

FIG. 2 is a block diagram of an advertisement bidding system that demonstrates an exemplary system for causing the display of video advertisements on a billboard in accordance with the principles of the present invention;

FIG. 3 is a block diagram of an advertisement bidding system that demonstrates an exemplary system for causing the display of video advertisements on a user computer based on search criteria entered into a search engine in accordance with the principles of the present invention;

FIG. 4 is a flow chart for receiving gender specific targeted advertisement bids in accordance with the principles of the present invention;

FIG. 5 is a flow chart for receiving sequential specific video targeted advertisement bids in accordance with the principles of the present invention;

FIG. 6 is a perspective view of the hand dryer configured to receive and display video advertisements in accordance with an exemplary embodiment of the present invention;

FIG. 7 is an exploded side view of the hand dryer configured to receive and display video advertisements from FIG. 6 in accordance with an exemplary embodiment of the present invention;

FIG. 8 is a perspective view of a hand cleaning station that includes an integrated soap dispenser, water nozzle, hand dryer and display device for video advertisements in accordance with an exemplary embodiment of the present invention;

FIG. 9 is a block diagram of an advertisement bidding system for causing the display of video advertisements from FIGS. 1-3 in accordance with the principles of the present invention; and

FIG. 10 is a perspective view of a digital mobile billboard for causing the display of video advertisements in accordance with the principles of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient electronic advertising system and method of video advertisement bidding. Embodiments of the invention provide a novel method of video advertisement bidding delivery.

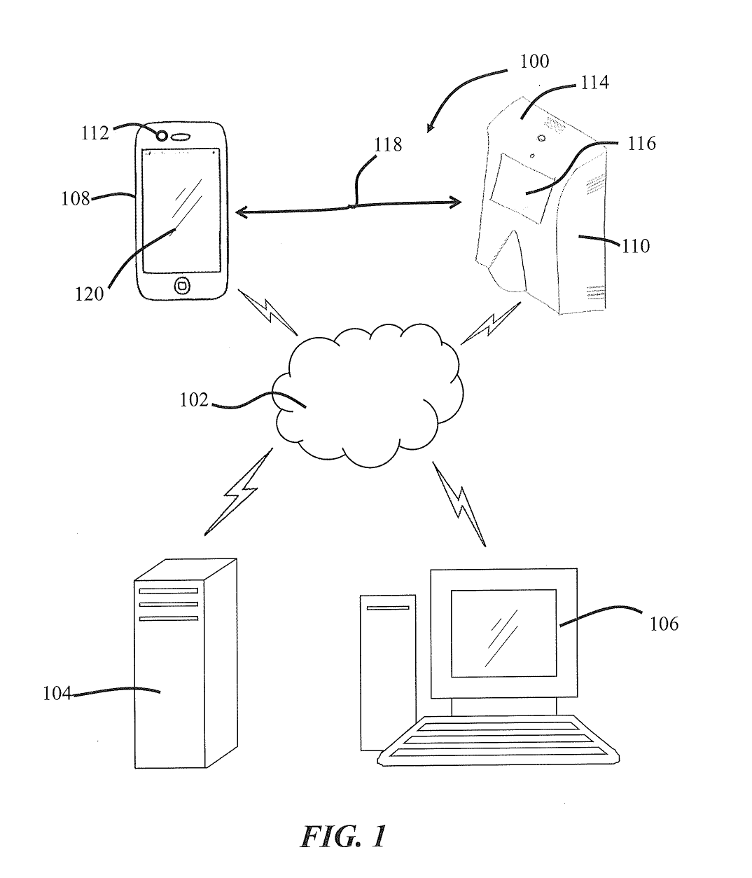

Referring now to FIG. 1, one embodiment of the present invention is shown in a block diagram. Although FIG. 1 shows several advantageous features of the present invention, as will be described below, the invention can be provided in several shapes, sizes, combinations of features and components, and varying numbers and functions of the components. The first example of a system 100 and method of video advertisement bidding is shown in FIG. 1. The system includes a network 102. Examples of networks include the World Wide Web and the internet, either of which may include various embodiments for radio communications such as a cellular communication network and the Public Switched Telephone Network (PSTN), or any other wide area network (WAN), as well as local area networks (LANS), such as an Ethernet LAN. Yet further, the network 102 may include High Speed Downlink Packet Access (HSDPA) systems, Global System for Mobile Communication (GSM) including General Packet Radio Service (GPRS) systems, Enhanced Data Rates for Global Evolution (EDGE) systems, CDMA/1×RTT systems, Evolution Data Only or Evolution Data Optimized (EV-DO), Evolution for Data and Voice (EV-DV) systems, High Speed Uplink Packet Access (HSUPA) systems, and any other like networks. The cellular communication network may include Code Division Multiple The network 102 may additionally be a wireless network, such as any type of satellite, Wi-Fi, ZigBee, infrared, Near Field Communications, Bluetooth, or other communication networks.

The network is capable of interconnecting a plurality of systems that include a server 104, an advertiser computing device 106, an advertisee device 108, and an advertisement device 110.

The server 104 may include any type of known server capable of managing information. In this case, information includes advertisements, bidding and the like. The server 104 may, in one example, be formed of a plurality of servers and databases.

The advertiser computing device 106 may be any known computing device capable of sending or receiving information over the network 102 to the server 104, the advertisee device 108, the advertisement device 110 and/or any other like devices. Information may be any data capable of being sent over network 102. The advertiser computing device 106 includes laptop computers, ultrabooks, smartphones, tablets, pcs, desktop computers and all other known and future computing devices.

The advertisee device 108 includes any computing device configured to process digital data, such as without limitation a portable computing device, a smart phone, and a tablet. The advertisee device 108 preferably includes a camera component 112 capable of capturing images. The advertisee device 108 is configured to scan bar codes, such as QR barcodes, via the camera component 112 for capturing advertiser information and permits the user to interact with the advertiser via advertisee device 106.

The advertisee device 108 includes a plurality of LED lights (not pictured) for illuminating. The LED lights may be positioned on the body of the advertisee device 108 or is otherwise illuminates from the advertisee device 108. In an embodiment, a sensor shall be positioned to sense the presence of at least one hand of a user, the sensor causes the LED lights to change illumination color and/or illumination patterns. The illuminations of the plurality of LED lights may vary in relation to the movement of a user's hands. The sensor may sense temperature. In an embodiment, the plurality of LED lights shall illuminate a particular color based on the temperature of at least one hand of the user. In an embodiment, the illumination color and/or illumination patterns may vary accordance to the facial expressions of the user, wherein the facial expressions may be captured by at least the camera component 112. In yet another embodiment, the LED lights may indicate or otherwise identify the time remaining for a hand drying session. For example, the lights may begin to dim over the duration of the hand drying process from the start of the hand drying session to the end of the hand drying session, or oppositely, brighten over the duration. In yet a further embodiment, a sensor may detect the amount of water on the individuals hands. The LED lights vary in brightness and color depending on the amount of water remaining on the users hands. For example, the LED lights may be a bright blue to indicate that the hands are wet, wherein the LED lights will gradually become white as the water on the hands evaporate.

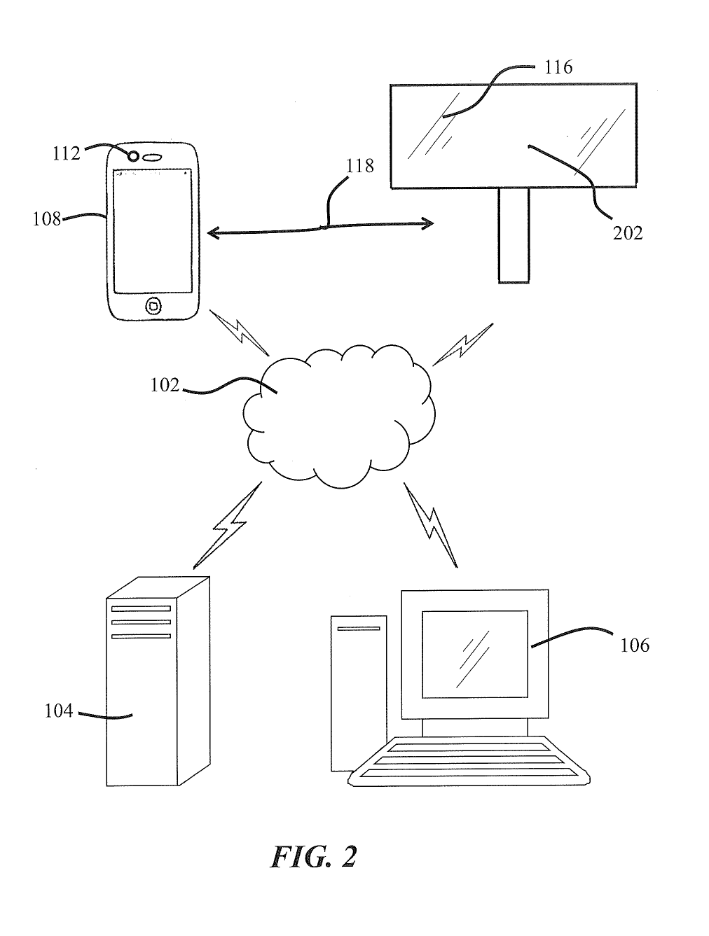

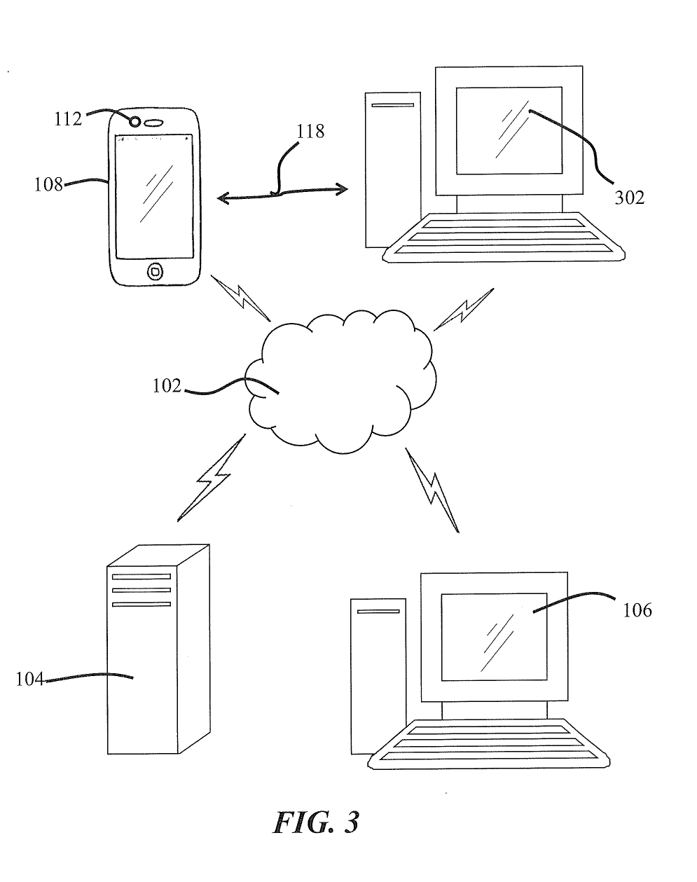

As depicted in FIGS. 1-3, the advertisement device 110 may be in the form of any digital display capable of providing a user with advertisements. The display may be integrated with a variety of configurations, including, inter alia, a personal computing device, a smart phone, a tablet computing device, a hand dryer and other known and unknown advertising space. Alternatively, the display may be a billboard capable of advertising to the targeted geographic location. The billboard may be a stationary electronic billboard, including without limitation electronic billboards commonly viewed roadside. Alternatively the billboard may be a mobile billboard, such as an advertisement billboard that is driven on roads via attachment to a vehicle. In yet an additional embodiment, the billboard may be a window front billboard or other known types of electronic billboard advertisement space. FIG. 2 depicts, for exemplary purposes, advertisement device 110 existing as a stationary billboard 202. FIG. 3 also depicts, for exemplary purposes, advertising device 110 existing as computing device 302. The computing device 302 is capable of accessing and performing searches via a search engine, such as GOOGLE and/or BING. Video advertisements are displayed on the computing device 302 resulting from the targeted search engine results.

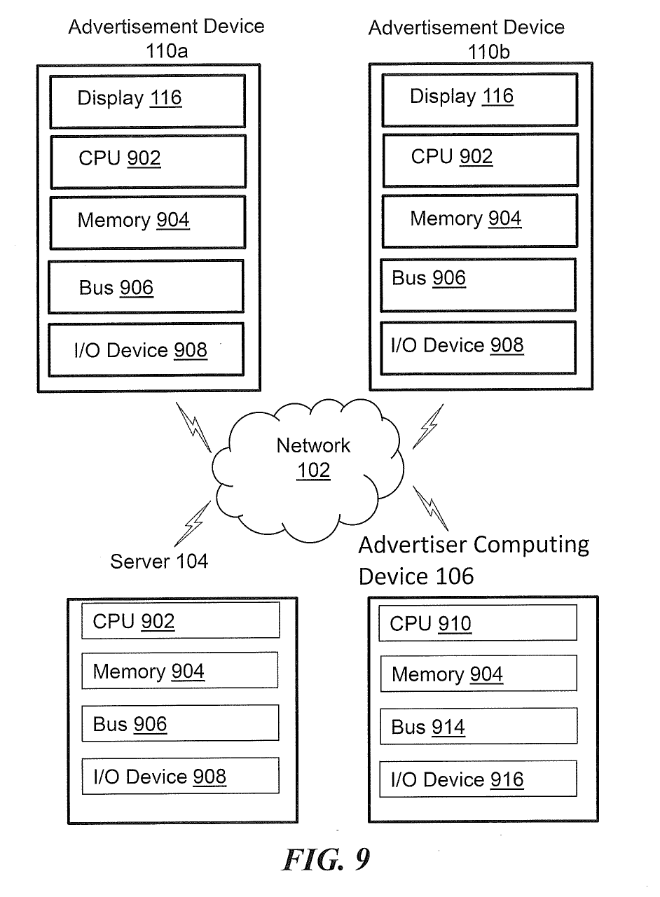

Each of the server 104, advertiser computing device 106 and multiple advertisement devices 110 a&b, include a combination of computing components, such as without limitation a CPU 902 for processing information, a memory 904 for storing information, input and output device 908 for receiving from and providing information to a user, and a bus 906 for transferring data between the components of the devices, as depicted in FIG. 9. CPU 902 may be any type of processor for processing data or other types of information capable of being processed by a processor. In addition, memory 904 refers to any physical devices configured for storing programs, including their sequence of instructions, or data, wherein the storage may be permanent or temporary. Each of the combination of computing components are configured to allow communication across network 102 between server 104, advertiser computing device 106, multiple computing devices 110 a&b, and advertisee device 108.

The digital mobile billboard is driven on roads via integration with a vehicle. The digital mobile billboard will include a display or other projection means for outputting the digital advertisement. A vehicle may include a means by which someone or something is carried, conveyed or transported, particularly by way of inland surface transportation, sea transportation or air and space transportation including limitation, cars, trucks, vans, railroad cars, boats, ships and planes. The mobile billboard is configured to receive advertisements to fill advertising space within the scope of the present invention, including through the use of a bidding system. Commonly, digital mobile billboards include a plurality of various advertisements that rotate based on a set amount of time. Nonetheless, the billboards are not displayed based on the advertisement bidding system disclosed in the present invention. Further, in an embodiment of the present invention, the digital mobile billboard is configured to display an advertisement based on additional criteria. For instance, the additional criteria may include location, time, dates and the like. The digital mobile billboard includes a location capturing device, such as a GPS or the like. The digital mobile billboard shall receive an advertisement. The advertisement may be chosen in accordance with the bidding system of the present invention. The digital mobile billboard shall additionally receive information for causing the display of the advertisement. For example, the digital mobile billboard may receive information that causes the display of the advertisement based on a particular location. For instance, the digital mobile billboard on a truck may receive information that causes a particular advertisement to display when the digital mobile billboard turns onto a particular road, such as Ocean Drive from 5^{th} Street in South Beach, Fla. The digital mobile billboard may additionally receive information that causes the advertisement to end, such that another advertisement or other digital information, or nothing at all, is displayed on the digital mobile billboard. For example, when the digital mobile billboard turns off of Ocean Drive, the digital billboard can change the advertisement displayed. This system and methods allows advertisers to purchase and/or bid on digital mobile advertising space based on the location of the vehicle. The system can be configured to permit advertisers to purchase space based on the amount of time that the advertisement is to be displayed. Alternatively, the system can be configured to permit advertisers to purchase space for a particular street. Alternatively, the system can be configured to permit advertisers to purchase space for a particular distance along a particular street. Yet further, the system can be configured to permit advertisers to purchase and/or bid on space for a particular distance along a category of locations.

The term “category”, as used herein, refers to a specific type of physical location and not only the location itself That is, a “category,” as the term is used herein, is non-geographic and, instead, identifies a kind of location for displaying an advertisement. For example, in one embodiment of the present invention, a non-geographic category of a location is a men's restroom. A second non-geographic category could be a women's restroom. Therefore, although the category, such as a restroom, occupies and can be identified by defining a geographic area, the actual geographic area that it occupies is not the sole selection criteria. There is an important distinction between the non-geographic categories of locations referred to herein and the geographic categories of locations used in the prior art. For example, users of traditional advertisement channels, such as TV or radio, purchase advertising to be displayed in a specific geographic location, such as a particular state, city, or a particular radius. Currently, one cannot actively select extremely specific categories of where their advertisements will be displayed. With known systems, the advertiser can only hope the desired person walks past. With the present invention, an advertiser can enjoy unprecedented pinpoint precision. For example, and advertiser can ensure that their material is only displayed in elevators in downtown Miami in buildings with over 20 floors. One can fairly safely rely on those criteria capturing a different demographic than an ad displayed at a bus stop in rural Michigan or in a skybox in Dallas, Tex.

In addition, the specific physical location may further include advertising on a specific display, such as a display in a restroom stall or a display above a restroom sink. Other examples of a non-geographic category of a location are the lobby of a specific building or type of building, e.g., office building or building with at least 20 floors, (or a specific display located in the specific building, e.g., the lobby), a specific area, e.g., display next to outdoor elevator, store front billboard, or in a parking shuttle at an airport. The categories of locations may define a specific electronic display located within a physical location having more than one possible electronic display device for advertising, thereby allowing an advertiser to select between specific electronic display devices located in the particular location. This system and method allows an advertiser to target their audience more precisely than the traditional system and method of advertising wherein traditional advertisements provide an advertisement based on the geographic location of any nearby electronic device that is configured and tuned to receive the advertisement, such as TV and radio advertisements. However, these traditional avenues for advertising do not allow the advertiser to select their audience with pinpoint precision, e.g., men in bathrooms of country clubs, women in shoe stores on Miami Beach, couples at ski lodges, etc.

In addition, traditional avenues for advertising, e.g., TV and radio, do not facilitate winning advertising space by outbidding competitors for desired categories of locations. Furthermore, traditional avenues for advertising do not allow the advertiser to select the particular device for displaying the advertisement.

Categories of non-geographic locations may be further defined as categories of restaurants for advertising only on an electronic display within restaurants. Categories of locations may be further defined as categories of night clubs for advertising only on an electronic display within nightclubs. Categories of locations may be further defined as categories of airports for advertising only on an electronic display within airports. Categories of locations may be further defined as categories of establishments for advertising only on an electronic display with that type of establishment. Likewise, categories of locations may be further define a specific type of location within the scope of the present invention.

Campaigns, such as GOOGLE ADWORDS, provide for advertising on a specific device; however, the advertiser does not and cannot choose the specific device. Instead, ADWORDS advertisers pick the type of audience they wish to advertise to, through the use of keywords or demographics and GOOGLE picks the device for displaying the advertisement. In GOOGLE ADWORDS, the advertiser has no control over the specific device on which the advertisement is displayed. Until this invention, there was no system available that allows users to select specific electronic displays for advertising. This may be partially because there previously was no system or method for a system to identify the non-geographic category of location of any particular electronic display device. Accordingly, the categories of locations do not encompass advertising techniques that are based simply on geographic location or other broad forms of advertising. For further example, TV and radio advertising is commonly based simply on the geographic location of the electronic device receiving the advertisement, or simply a demographic. TV, radio and other directed advertisements are not targeting a specific electronic display at a specific location. Instead, TV and radio advertising may include specific goals, such as targeting specific criteria, but is not related to a specific display device or a specific category of location. Notably, the categories of locations does not encompass an advertiser who simply wishes to advertise based on a geographic location, such as in Southern Florida, regardless of whether the geographic location is also based on additional information such as demographics.

In an embodiment, the specific categories of locations, as defined above, for displaying advertising may be narrowed based on additional information such as demographics, such as traffic levels, identified target audiences and the like. Once a targeted audience is identified, the specific electronic device or devices may be chosen. The categories of locations may further define specific electronic devices located within specified geographic areas, such as beaches, malls, gyms, schools, sports venues/arenas, high populated areas, low populated areas, high traffic areas and low traffic areas, to name just a few exemplary categories of locations.

In an embodiment, the advertiser may select which side of the street the advertisement shall face. Commonly, mobile billboards advertise on two sides of the vehicle to target each side of the street. The advertiser could purchase and/or bid on advertisement space for at least two sides of the vehicle. However, this would also allow at least two advertisers to advertise at the same time. For example, a first advertiser could advertise on a display device on the first side of the truck and another advertiser could advertise on a display device on the other side of the truck. In this way, advertisers could purchase and/or bid for advertising to a particular direction. For example, the advertiser may wish to advertise to the patrons on the west side of Ocean Drive. However, this is problematic because the truck may be driving north on Ocean Drive but it could also drive south on the same road. Thus, the digital mobile billboard, using a location capturing device and methods, such as a GPS unit, is able to determine the direction that the vehicle is driving. From the direction that the vehicle is driving, the digital mobile billboard will display the advertisement towards the appropriate side of the street. The advertising, in accordance with the rest of the invention, may be purchased and/or bid on for a particular time of day and date, such that the advertisement is displayed only within that window.

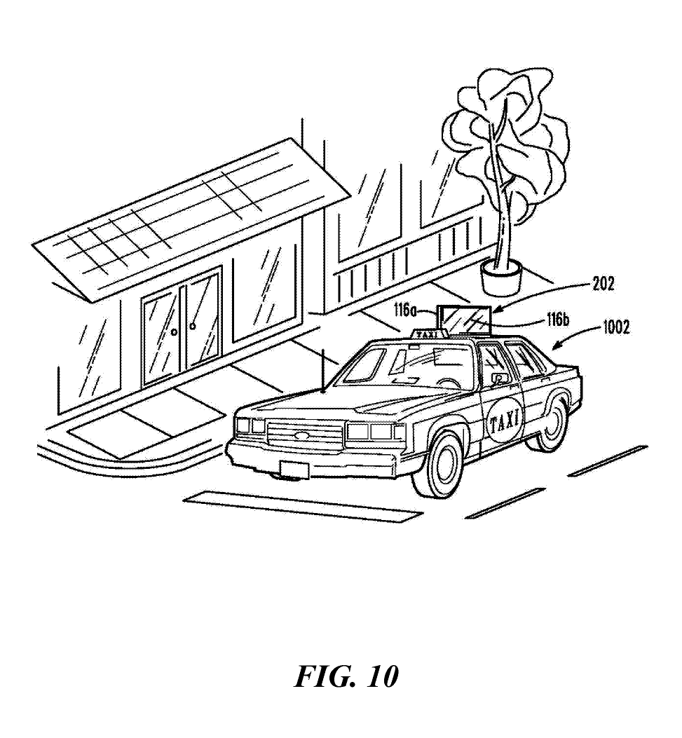

A plurality of vehicles may each be fitted with at least one digital mobile billboard. In an embodiment, an advertiser may purchase and/or bid on a particular location for displaying the digital advertisement on any number of digital mobile billboards within the specified criteria. That location may be, in effect, any vehicle equipped with a digital mobile billboard capable of displaying the digital advertisement. For example, as depicted in FIG. 10, digital mobile billboards may be mounted to taxi cabs 1002 and buses (not-pictured). As with the taxi cab 1002, there is no guarantee where that vehicle will travel throughout the day. Additionally, any particular bus may only pass a particular location a few times throughout a day. Because digital mobile billboards only drive on a particular street a number of times throughout a day, if at all, it is desirable to display advertisements across a multitude of digital mobile billboards in order to increase the number of times that the advertisement is displayed wherein the particular advertisement displayed is based on the location of the digital mobile billboard. In accordance with the spirit of the present invention, the advertisement may be displayed on any number of digital mobile billboards when any those billboards are within a specified location. The digital mobile billboards may use GPS or other location capturing devices and methods for ascertaining the billboard's location. Each taxi cab may be fitted with a digital mobile billboard having a display 116a facing one side of the street and a display device 116b facing another side of the street. Each taxi cab 1002, as an example of the operation, driven onto a particular street, such as Ocean Drive, displays a particular advertisement within the scope of the present invention. This is particularly useful to provide meaningful advertising. A local restaurant or bar would prefer to advertise to effectively capture market share. Thus, it is more useful for a local restaurant or bar to advertise to patrons in particular locations. A local restaurant on Ocean Drive, for instance, may only be interested in advertising to patrons walking within two blocks of the restaurant.

Similarly, a plane may display an advertisement based on the location of the plane. For example, a plane carrying a digital mobile billboard may display a first advertisement as the plane passes South Beach, a second advertisement as the plane passes North Miami Beach, a third advertisement as the plane passes Hollywood Beach, and a fourth advertisement as the plane passes Fort Lauderdale Beach. Commonly, planes displaying advertisements are limited to advertising at a particular location, such as a South Beach, because the advertisements carried commonly advertise a local business. Accordingly, it would not be cost effective to advertise a South Beach restaurant at Fort Lauderdale Beach. Additionally, planes currently include the same advertisement throughout the entire flight. Planes commonly return to the airport in order to switch the advertisement trailing behind them. However, it is not effective for a business, such as a restaurant, to advertise across the entire plane flight because planes travel long distances very quickly. For this reason, planes commonly advertise to locations that are too far to provide any meaningful business. For example, the northern most part of South Beach is a large distance from the southernmost part of South Beach. This large distance causes advertisers to advertise to an audience unlikely to be willing to travel that large distance to the advertiser's establishment. Thus, it is desirable to attach a digital mobile billboard to a plane to allow advertisers to purchase and/or bid on advertising space for a particular location, in accordance with the spirit of the current invention. In this regard, advertisers advertising on mobile digital billboards flown by planes can advertise to a more targeted audience. This allows advertisers to purchase and/or bid on advertising space for advertising when the plane is within a particular geometric location during the flight.

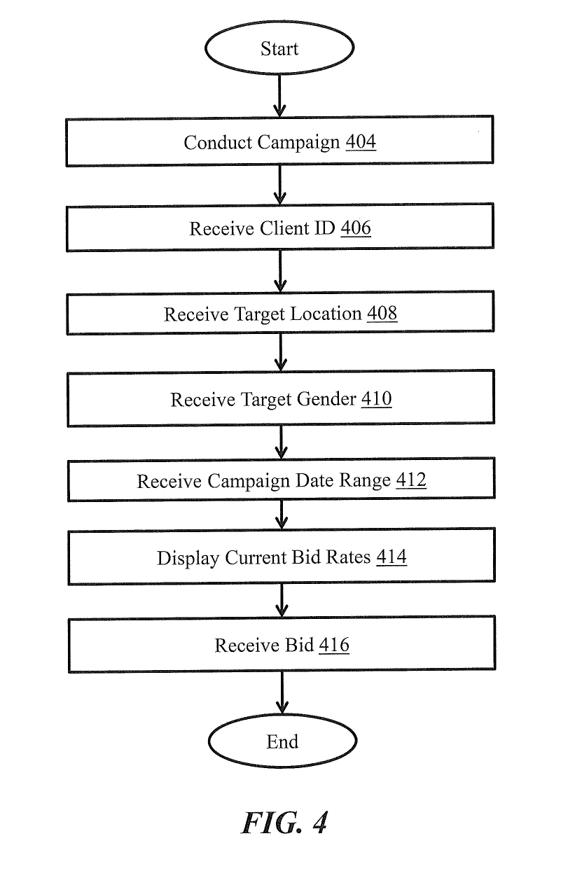

Referring now to FIG. 4, a method is provided for providing and receiving targeted video advertisements via a bidding system. At block 404, the method includes conducting an advertisement campaign. In operation, the advertiser computing device 106 receives digital data from the server 104 for bidding on the campaign. Advertisement related information includes, without limitation, any information necessary to track a plurality of bidders, such as a client ID, payment information, preferred advertisement locations and the like. The advertiser enters advertisement related information and sends that information across the network 102. The advertiser computing device 106 sends the client ID to the server 104 for identification. At Block 406, the server 104 receives the client ID relating to the advertiser. While it is contemplated that the advertiser computing device 106 will associate bids to a particular user ID; it is additionally contemplated that the bidder may be completely or partially anonymous.

At block 408, the advertiser will input the target location that causes the display of an advertisement subsequent to a winning advertisement bid campaign. The location may be based on a specific advertisement device; for example, the device may be one particular hand dryer 114 located at a particular night club in South Beach, or a billboard 202 off of, for example, Interstate 95. It is an object of the present invention to provide an advertisement bidding system that permits the advertiser to select the particular device that will display an advertisement subsequent to a winning bid.

Alternatively, the advertiser may select each particular device to display the advertisement at a geographic location, such that the advertisement will display for multiple advertisement devices 110 located within a particular geographic location. The advertisement may include more than one unique advertising segment, such that the advertisement may include multiple segments to be displayed on the multiple advertisement devices. Each advertising segment is unique from the other segments. For example, one segment may consist of a 30 second advertisement segment and another segment may be a 60 second advertisement segment. The advertiser may bid for advertisement space collectively for the multiple segments. The advertiser may select or otherwise indicate which advertisement device shall display which advertising segment for a winning bid. The particular geographic location may be defined by a number of criteria, such as a proximity, a distance, a radius, or like criteria. In an embodiment, the location for display of the advertisement and/or the advertisement segment may be chosen at random. In the past, advertisers have been limited to advertising in a particular geographic location, but have not had the opportunity to bid for specific electronic display device space.

In an embodiment, advertisers may bid on distinct categories of advertising space. Categories may be defined as different types of locations; e.g., men's bathroom, women's bathroom, a doctor's office waiting room, a lobby of a building, or the like. Categories may be distinguished based on the likelihood of being viewed by a particular gender. The categories may relate to an exclusive location selected by the advertiser. The advertising device selectively displays advertising content only on the selected one of the at least two different categories of locations. The term “only” is defined as “exclusive”. Thus, an advertisement that is only on the selected one of the at least two different categories of locations is exclusive to one category of locations. For example, the advertisement content may be exclusive to women's bathrooms. This would allow digital advertisers to effectively target a particular audience.

The term bathroom and lavatory are interchangeable. The term bathroom refers to any room fitted with a shower, wash basin, and/or a toilet. A bathroom with a wash basin may be configured for washing the hands and face. Furthermore, the term bathroom may include a number of categories, such as men's bathrooms, women's bathrooms, co-ed bathrooms and family bathrooms.

Categories may further be defined to include gender specific categories for targeting a majority of men or a majority of women. Additionally, the categories further define an age range, social or economic status, education levels, ethnicity, and/or race. The categories may be based on locations that are associated with specific demographics. For example, men's bathrooms would reach male advertisees, but rarely, if ever, reach women advertisees. As a further example, a particular bar or night club may be a location known for a particular range of patron ages, etc. Alternatively, the categories may be based on the type of advertisement space.

In an embodiment, the advertiser will input into the advertiser computing device 106 criteria that will influence which of a plurality of advertisement devices 110 that the advertiser will bid for advertisement space. For example, the advertiser may input from a selection a bid to advertise in an airport, restaurant, bar, hotel, mall, terminal, stadium, and many others. The server may suggest particular hot spots that are keyed to the categories or demographics provided by the advertiser. In which case, the advertiser may include the suggested locations or categories. Sequential bids are accepted from a plurality of advertisers wherein sequential defines the logical order and/or sequence of advertisement bids.

A losing bid from a second advertiser will permit the second advertiser to advertise on a different space than the previously selected bid's first choice for advertisement space. Alternatively, the advertiser may choose a first location for advertising and at least one alternate location for advertising. The advertisement relating to the losing bid may be displayed at the alternate location subsequent to losing the bid for the first location. Alternatively, the advertisement relating to the losing bid may be displayed at a location not specifically selected by the advertiser. For example, server 104 may select the particular display for displaying the advertisement relating to a losing bid.

At block 410, the server receives information—preferably received from the advertiser—relating to the target gender for targeted advertisements. In an embodiment, the advertiser will input into the advertiser computing device 106 criteria that will dictate the target gender for subsequent targeting of advertisements on the displays 116 located in gender specific locations, such as restrooms, women-only health clubs, and the few remaining male-only golf courses. Of these and also non-gender specific locations, the display 116 may be integrated with the hand dryer 114 located in restrooms for providing control over gender targeted specific advertisements. The advertiser may select from an audience of only males, only females or a combination thereof Unlike any other advertisement bidding system, the present embodiment is uniquely capable of providing an advertisement bidding system configured to accurately target a specific gender at least when the display device 116 is integrated with a hand dryer 114 located inside a gender specific bathroom. Accordingly, no additional advertiser information is necessary to most accurately determine the gender of the advertisee. This permits the unique idea of gender specific advertising without resorting to a user generated profile or other like methods of determining the gender of the advertisee.

The advertisement bidding system is uniquely configured to accept bids for advertising space and is particularly suited for video advertisements. In operation, this permits video advertisement campaigns to be sold to the highest bidder. In contrast to existing bidding systems, the instant embodiment permits targeted bidding, wherein the targeting is based on criteria such as location, type of venue and the like, but is not based on the more traditional type of advertising based on user search terms—a type of personal information—or other personal information used within traditional internet advertising. The implementation of an advertisement bidding system into restroom hand dryers provides for a unique targeting of advertisees. Subsequent to selecting a winning bid, the server 104 charges the advertiser. The charge may be a credit card charge, a debit card charge or other known means for electronic payments.

The advertiser may alternatively select the choice of displaying advertisements to both males and females in unisex or family restrooms. Furthermore, the advertiser may additionally be interested in advertising within family restrooms for targeting the young family demographic, as families with young children frequent these facilities.

In an embodiment, the advertiser may input or otherwise adjust the number of displays that the advertiser will bid on for advertising space. In operation, the advertiser may bid on one display or bid on one hundred displays; the number of displays is limitless. Unlike conventional bidding, in one embodiment of the present invention an advertiser may select the exact display for which the advertisement will be displayed subsequent to a winning bid.

In an embodiment, the advertiser may bid for advertising space in a digital virtual magazine in accordance with the principles of the instant invention. The magazine may be located within a device located within a non-geographic category of locations in accordance with the spirit of the present invention. Alternatively, the advertiser may bid for advertising that will be displayed on the screen of any device through a virtual magazine application or webpage. The digital virtual magazine may include a QR code located in the bottom portion of the screen. The digital virtual magazine may include advertisements located in a location near the QR code on the bottom portion of the screen. For example, the QR code may be located on the bottom left side of the screen, whereas the advertisements are located at the bottom right of the screen.

In block 412, the advertiser will input a date selection for the advertisement campaign. The advertisement campaign may be narrowed by day, month, year, as well as broken down by specific hours and minutes.

A winning bid will provide the advertiser a certain amount of total time for advertising content on advertising space. The total time may consist of a block of time for advertising during that block. Alternatively, total time may be deducted only during the periods that the advertisement is shown or displayed on display device 116. For example, the hand dryer may only display advertising content on display device 116 during a hand drying cycle. Thus, the total time for advertising is reduced in relation to the length of the hand drying cycle.

In block 414, the advertiser's display will display the current bid rates of at least one location based on the prior selections of the advertiser. In an embodiment, the current bid rates are received by advertiser computing device 106 from server 104 over the network 102 for displaying the current rates to the advertiser. The advertiser computing device 106 is configured to display additional recommended advertisement bid campaigns received from the server 104. For example, based on the criteria selected, the server 104 will transmit data that includes recommended campaign data over the network 102 for display on the advertiser computing device 106. The recommended campaign data includes the current cost to bid on a campaign spot. In an example, recommended campaign data is displayed to an advertiser to recommend a particular advertisement campaign based on advertiser preferences, past campaigns, cost per campaign, and/or similar criteria. The server 104 may provide data to help the advertiser choose the best possible advertising space based on the other advertisers at a particular location. For example, a manufacturer may wish to advertise in establishments that sell its products and not advertise in locations where a competitor's products are exclusively sold, or vice versa.

In further operation, the campaign spot may be based on the cost per day. In one example, the advertiser may bid on the spot per day. The server 104 may require a bid for each unique day such that bidding on advertising spots for ten days requires ten individual bids. Alternatively, the advertiser may be able to bid for a block of time. The block may be based on any known time frame, e.g., every Monday for a month; every weekend night between 9 p.m. and 3 a.m. for two weeks, or any other possible combination. It is contemplated that the cost for an initial opening bid may vary in relation to the location, the time of day, amount of foot/road traffic, gender, prestige, and other like factors, or simply be arbitrarily set.

In block 416, the server 416 receives at least one bid for an advertising campaign. The campaign will allow advertisers to submit bids for advertising space until a period of time prior to the commencement of the advertisement campaign. For example, bids may be accepted until a period of 24 hours, 48 hours, or 72 hours prior to the commencement of the advertisement campaign display.

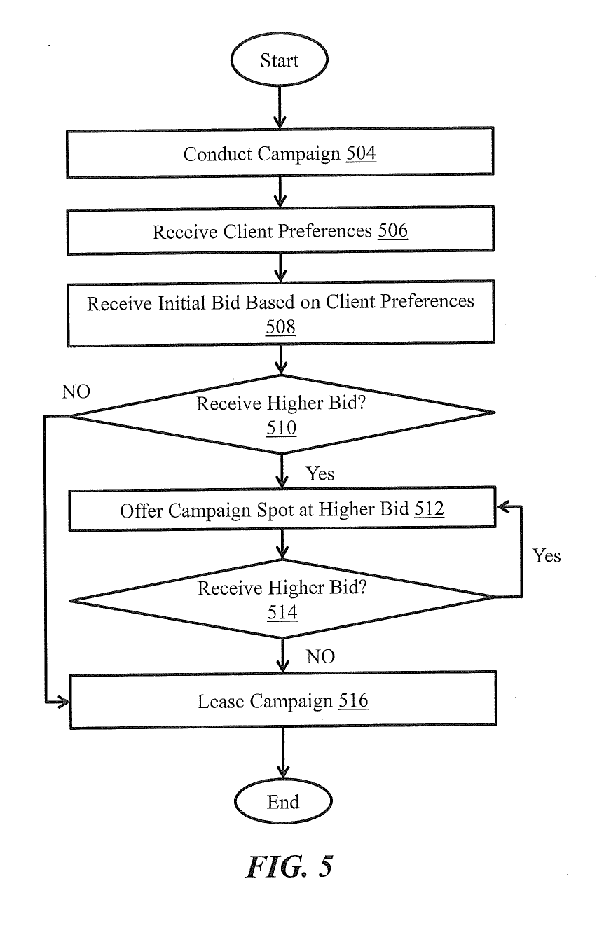

Referring now to FIG. 5, a method is provided for receiving sequential specific video targeted advertisement bids in accordance with the principles of the present invention. At block 504, the method includes conducting a campaign according to the principles disclosed by the elements operatively disclosed in FIG. 4. At block 506, the server 104 receives data over the network from advertiser computing device 106. At block 506, the server receives data relating to the advertiser preferences, such as the information received at blocks 406-414. At block 508, the server 104 receives an initial bid for an advertisement campaign. The bid may remain open for a period of time. In an example, the bid remains open for a period of 24 hours, 48 hours, or 72 hours prior to the commencement of the advertisement campaign display. Alternatively, the bid remains open for a period of time following an advertiser bid. In an embodiment, the time to bid on an open advertisement campaign space may increase for each subsequent bid. Alternatively, the advertiser may be capable of buying now, causing the close of auction and preventing future bids for the advertising space.

At block 510 the server 104 waits to receive a higher bid for the advertisement campaign space. If a higher bid is not received, the server 104 will lease the campaign space to the advertiser. Alternatively, at block 512, if the server 104 receives a higher bid for the campaign space, the server 104 will permit an advertiser to bid for the campaign space at a price greater than the previous bid. The server 104 continues to permit higher bids for the campaign space until at least one of the time periods expires, no additional bids are received, or an advertiser purchases the campaign space outright. At block 516 the campaign closes and the advertisement space is leased to the advertiser. The resulting advertisement will display on the advertisement device 110 in accordance with the spirit of the invention.

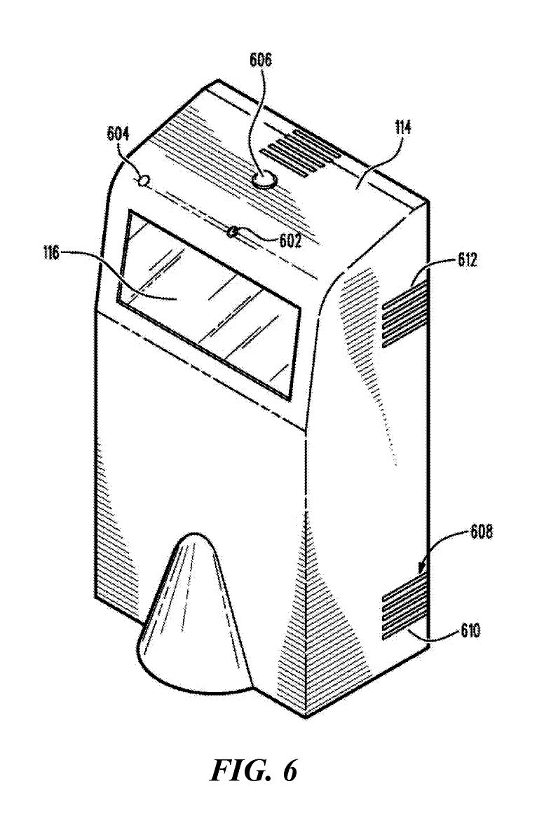

Referring now to FIG. 6, a port 612 is disclosed for permitting sound, such as music, from a speaker (not pictured) to reverberate or otherwise pass. The speaker may be configured to increase in volume during the operation of the hand dryer such that the speaker overcomes the increased hand dryer noise. The sound may include advertisement information in conjunction with the video advertisement within the scope of this invention. FIG. 6 further discloses a hand dryer 114 with an electronic display device 116. The display device 116 is configured for displaying at least one of advertisements and advertisement campaigns. The hand dryer includes a camera 602. The camera is configured to be forward facing in relation to the display device 116 to capture images of the user. It is not necessary that the camera is faced at the same outward facing direction of the display device 116. Instead, the camera is positioned for capturing an image of the user during operation of the hand dryer. In operation, the user is positioned for both hand drying and viewing of an advertisement on the display device 116. The images may be used for such purposes as at least one of facial recognition, and uploading to a social media website. The images may be integrated into an advertisement on a social media website. The advertisee may receive discounts or other coupons for allowing the upload of images from the camera device.

The facial recognition may be useful in airport bathrooms as a security measure to detect unscrupulous individuals and others on the do-not-fly list. The captured images may be sent over the network 102 to a security server (not pictured) for performing facial recognition analysis. Alternatively, the images may be useful for interactive advertising of a particular business for which the hand dryer is located. In one embodiment, the camera feed may be implemented to display the user onto the display device 116, thereby providing a mirror equivalent. In an embodiment, the combination of a camera and an interactive advertisement causes the advertisee to be integrated into the advertisement displayed on the display device 116. Element 604 may be a button, sensor or other like components for causing the interruption of the advertisement for the purposes of displaying the user on the display device 116. When element 604 is a sensor, the user may waive their hand near the sensor to cause the display of the camera image on the display device 116. In this way, the user is capable of accessing a mirror function without touching the hand dryer, which is particularly useful in bathrooms for hygiene purposes. The sensor 604 provides a method of interrupting the advertisement to provide a mirror to the user or causing integration of the advertisee into the advertisement being displayed.

The advertisement may cause the display of a QR code on the display device 116. The camera component 112 of the advertisee device 108 is configured to capture information 118, such as a QR code and provide information based on captured information on the advertisee display 120. In operation, this allows the advertiser to engage the advertisee after the advertisee is no longer in view of the advertisement displayed on display device 116. Through this method, the advertiser may further capture additional advertisee information and engage the advertisee with subsequent information on advertisee display 120 provided through network 102. As depicted in FIGS. 2-3, the advertisee device 108 is similarly configured to capture transmitted information 118, such as a QR code from an electronic billboard 202 having a display 116 or a display 116 of a computing device 302. In the case of the billboard 202, the QR must be sufficiently large to allow the capture of the image at a significant distance. For instance, the distance between the camera component 112 and the QR code on the billboard may include without limitation a distance of one hundred (100) yards or more.

In an embodiment of FIG. 6, display device 116 may display a sponsor advertisement that is purchased and/or bid on by an advertiser. That sponsor advertisement displays prior to the activation of the hand dryer. Upon activation of the hand dryer, the sponsor advertisement is interrupted. Additionally, the activation of the hand dryer causes a different advertisement to be displayed over the course of the drying operation. Subsequent to the operation of the hand dryer, the sponsor advertisement continues to advertise.

Display device 116 may receive information from server 104 indicating an amber alert defining a child abduction notification. The amber alert may include all pertinent information necessary to identify and notify the authorities of the abductors location.

The display device 116 may further display other safety messages such as fire alarm alert messages. Fire alarm alert messages may alert to the presence of a fire within the building. Fire alarm alert messages are particularly important for bathrooms because bathrooms commonly only have one exit point making bathroom patrons extremely susceptible to dangerous conditions in the event that a fire overcomes the bathroom entrance. The display device 116 may display the appropriate path of evacuation.

Element 606 is a sensor, such as a laser, for capturing the number and/or the flow of advertisees within a defined proximity to the display 116. The number of advertisees may be used to set the initial price for each particular advertising space. Additionally, statistical analysis provided by the element 606 is useful for the advertisers to select locations for their advertisement campaign. The statistical analysis captured by element 606 may be utilized by server 104 for computing suggested campaign locations for individual bidders. The captured information may be provided to server 104 for analysis. Alternatively, analysis is computed within advertisement device 110.

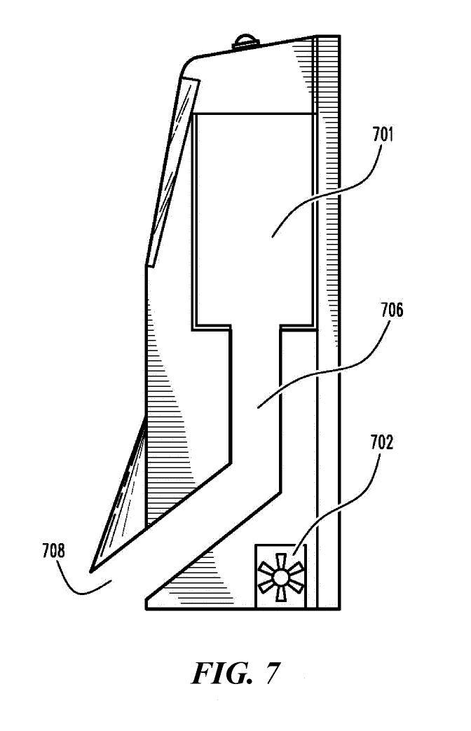

FIGS. 6-7 depict an air return system 608 that includes at least one port 610 or other openings in the casing of the hand dryer 114 for permitting air to flow into and out of the body of the hand dryer. A fan 702 causes air to flow through the hand dryer 114. An ultraviolet light source (not pictured) is positioned to condition the air flowing through the return system. The expelled air is conditioned or otherwise sanitized from the ultraviolet light source for the purpose of reducing odors and increasing the cleanliness of the air in the room for which the hand dryer is mounted.

FIG. 7 further depicts a portion of the inner components of the hand dryer including the motor component 701 and the airport 706. Air pressure generated by the motor component 701 shall exit the hand dryer at a bottom aperture 708 or in other known and conventional manners. It is contemplated that any known system and method for hand drying may be combined to accomplish the spirit and scope of the instant invention.

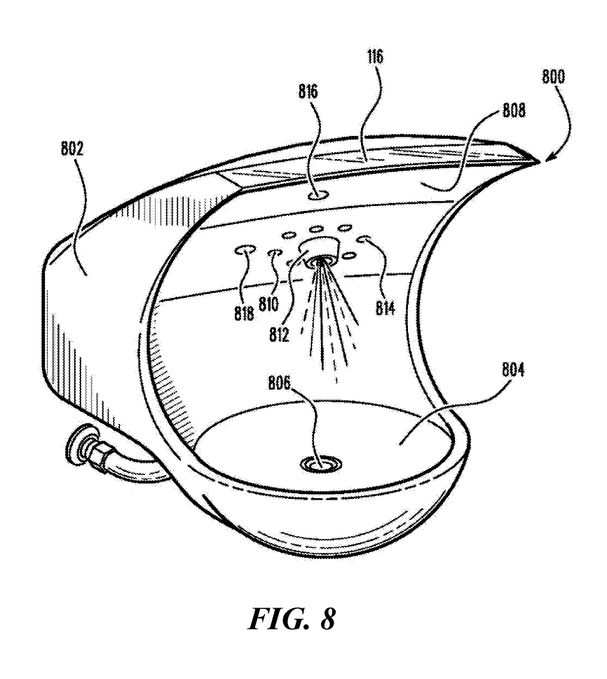

FIG. 8 depicts an all-in-one hand washing station providing multiple cycles for washing and drying of one's hands with one apparatus. The all-in-one hand washing station results in a cleaner restroom because the person will both wash and dry their hands before removing their hands from above the lower component 804, and thus, water and other liquids are maintained within the washing station instead of soiling the countertop and floors of the restroom while the user reaches for a paper towel and/or moves to the hand dryer. The hand washing station 800 includes a sink component 802. The sink component 802 includes a lower component 804 configured for receiving water, soap, hand sanitizer, and the like. The lower component 804 defines at least in part a bowl, wherein the bowl may be of any shape configured to capture water like a conventional sink for displacement about a drain 806. The drain 806 is configured for discharging liquids, soaps, sanitizers, and the like. In a preferred embodiment, the hand washing station 800 includes an upper component 808 with at least a portion of a plurality of disbursing nozzles discharging above and/or into the bowl of the lower component 804, the nozzles configured to disburse at least one liquid. The upper component 808 includes a plurality of nozzles 810-814 configured to discharge liquids, soaps, sanitizers and the like. The upper and the lower components may or may not be continuous and/or joined together. Additionally, the upper and lower components may or may not be formed together. In an embodiment, at least a portion of the upper component is situated above at least a portion of the lower compartment for causing flow of a liquid from the upper compartment into the bowl of the lower compartment. The upper component includes a first soap dispensing nozzle. A sensor 818 is positioned to detect the presence of a hand. Upon detection of a hand, a first cycle of the hand washing station 800 shall cause the disbursement of soap 810, preferably onto the user's hands. After a set time period, a second cycle of the hand washing station 800 shall cause the water to flow from nozzle 812 for a period of time. After the hand washing station 800 causes the water to cease flowing from the nozzle 812, a third cycle of the hand washing station 800 causes the hand dryer 816 to activate causing air to flow at a rate capable of drying the user's hands. Vent 816 is configured to permit air to flow at a rate capable of drying a user's hands. At the conclusion of the drying cycle, a fourth cycle of the hand washing station 800 causes disbursement of sanitizer onto the users hand's. It is contemplated that each cycle may be provided in any order and may be redundantly applied such that each individual cycle may occur multiple times during the complete cleaning cycle. For example, the water may cycle multiple times before and after the disbursement of soap.

The hand washing station 800 includes a display 116 that permits the user to watch advertisements or other media in accordance with the spirit and scope of the instant invention. It is particularly advantageous to provide an all-in-one hand washing station in accordance with the spirit of this invention in order to increase the time for which a user may be targeted with advertising material, as opposed to simply supplying a video advertisement on a conventional dryer. In conventional dryers, the user will only view the dryer for the period of time that the user is drying their hands. However, the all-in-one hand washing station provides the additional time during an introduction period, as well as during the application of the soap, water, and sanitizer. The introduction period may be included or be defined as a video or graphical depiction to educate the user on the operation of the invention or to otherwise greet the user.

What is claimed is:

1. An electronic advertising system comprising:
a plurality of electronic display devices mounted in at least two different non-geographic categories of locations;
a server operable to receive from an advertiser a selection of one of the at least two different non-geographic categories of locations; and
a processor communicatively coupled to the server and the plurality of electronic display devices and operable to selectively display advertising content only on the selected one of the at least two different non-geographic categories of locations.

2. The electronic advertising system according to claim 1, wherein:
a first one of the at least two different non-geographic categories of locations is a men's lavatory and a second one of the at least two different non-geographic categories of locations is a women's lavatory.

3. The electronic advertising system according to claim 1, wherein:
the server is further operable to receive, from at least two advertisers, at least two bids for displaying the advertising content in one of the at least two different non-geographic categories of locations; and
the processor is further operable to identify a winning bid based on at least the value of the at least two bids.

4. The electronic advertising system according to claim 3, wherein:
the server is further operable to receive, from the at least two advertisers, at least two bids submitted in sequential order for a video advertisement in one of the at least two different electronic display devices located in a single non-geographic category of locations; and
the processor is further operable to identify a winning bid based on at least the value of the at least two bids for a video advertisement in one of the at least two different electronic display devices located in a single non-geographic category of locations.

5. The electronic advertising system of claim 3, wherein:
the processor causes a display of the video advertisement on a selected one of the electronic display devices located in the winning non-geographic category.

6. The electronic advertising system according to claim 1, further comprising:
a switch configured to interrupt the advertising content on at least one of the electronic display device.

7. The electronic advertising system according to claim 6 further comprising:
a camera feed displaying on at least one of the electronic display devices after the interruption of advertising content.

8. The electronic advertising system according to claim 1 wherein the plurality of electronic display devices are mounted on a mobile vehicle for providing a digital mobile billboard.

9. The electronic advertising system according to claim 1 wherein the plurality of electronic display devices include at least one of:
a display on an hand dryer;
a display above a urinal;
a display within a restroom stall; and
a display above a sink.

10. A method for advertising, the method comprising:
receiving, from at least two advertisers, over an electronic network, at least two bids for video advertisement space on at least one electronic display device located within a selected one of a men's lavatory and a women's lavatory;
identifying a winning bid; and
selectively displaying, for the advertiser submitting the winning bid, advertising content on the selected electronic display device.

11. The method for advertising of claim 10 wherein the video advertisement space is within a selected one of at least two different categories of business establishments.

12. The method for advertising of claim 11 wherein at least two different categories of business establishments are non-geographic categories.

13. The method for advertising of claim 10 further comprising:
interrupting, via a switch, the advertising content, wherein the interruption of the advertising content causes at least one camera image to display on the selected electronic display device.

14. The method for advertising of claim 10 further comprising:
selectively displaying, for the advertiser not submitting the winning bid, advertising content on a selected second-choice electronic display device

15. A method for advertising, the method comprising:
mounting a plurality of electronic display devices in at least two different non-geographic categories of locations;
receiving from an advertiser, through a server, a selection of one of the at least two different non-geographic categories of locations; and
selectively displaying advertising content only on the selected one of the at least two different non-geographic categories of locations.

16. The method according to claim 15, wherein:
a first one of the at least two different non-geographic categories of locations is a men's lavatory and a second one of the at least two different non-geographic categories of locations is a women's lavatory.

17. The method according to claim 15, further comprising:
receiving, from the at least two advertisers, at least two bids for displaying the advertising content in one of the at least two different non-geographic categories of locations; and
identify a winning bid.

18. The method according to claim 17, further comprising:
receiving, from at the least two advertisers, at least two bids for a video advertisement in one of the at least two different electronic display devices located in a single non-geographic category of locations; and
identifying a winning bid based on at least the value of the at least two bids for a video advertisement in one of the at least two different electronic display devices located in a single non-geographic category of locations.

19. The method of claim 17, further comprising:
selectively displaying, for the advertiser not submitting the winning bid, advertising content on a selected second-choice electronic display device
